(19) United States
(12) Patent Application Publication
(10) Pub. No.: US 2026/0019751 A1
(43) Pub. Date: Jan. 15, 2026

(54) MULTIFUNCTIONAL SOUND GENERATING DEVICE

(71) Applicant: AAC Microtech (Changzhou) Co., Ltd., Changzhou City (CN)

(72) Inventors: Bo Xiao, Changzhou (CN); Ronglin Linghu, Changzhou (CN); Weiwei Tao, Changzhou (CN); Fan Zhang, Changzhou (CN)

(21) Appl. No.: 19/001,505

(22) Filed: Dec. 25, 2024

Related U.S. Application Data
(63) Continuation of application No. PCT/CN2024/104994, filed on Jul. 11, 2024.

(51) Int. Cl. H04R 9/02; H02K 33/18; H04R 1/02; H04R 9/06

(52) U.S. Cl. CPC H04R 9/025; H02K 33/18; H04R 1/025; H04R 9/06; H04R 2400/03; H04R 2400/11

(57) ABSTRACT

A multifunctional sound generating device is provided and includes a housing, a vibration unit received in the housing, and a driving coil configured to drive the vibration unit to vibrate. The vibration unit includes a sound generating unit and at least one magnet assembly fixed to the sound generating unit. The sound generating unit includes a basin frame, and a vibration system and a magnetic circuit system respectively fixed on the basin frame. In the multifunctional sound generating device of the disclosure, the magnetic circuit system and the magnet assembly are integrated with each other to improve the overall mass and driving force of the vibration unit, thereby improving the BL value and the vibration sense of the multifunctional sound generating device and improving the performance thereof.

### CROSS REFERENCE TO RELATED APPLICATIONS

The present application is a continuation of PCT Patent Application No. PCT/CN2024/104994, filed July 11, 2024, which is incorporated by reference herein in its entirety.

### TECHNICAL FIELD

The various embodiments described in this document relate in general to the technical field of vibration motors, and more specifically to a multifunctional sound generating device.

### BACKGROUND

With the continuous innovation of intelligent mobile devices, the intelligent mobile devices are more and more popular by users. The most common intelligent mobile devices are mobile phones, tablets, and handheld game consoles, and the like. For the intelligent mobile devices, both playback functions and vibration functions has become a basic function of the intelligent mobile device. Therefore, multifunctional sound generating devices with the playback function and the vibration function have been widely used in the intelligent mobile devices.

The multifunctional sound generating device mainly includes a housing, a vibration unit elastically supported in the housing, and a driving coil for driving the vibration unit to vibrate. The vibration unit includes a sound generating unit for playing sound and a magnet (e.g., magnetic steel) assembly for providing a vibration force perpendicular to a vibration direction of the sound generating unit. The sound generating unit mainly includes a basin frame, and a vibration system and a magnetic circuit system that are fixed to the basin frame, where the magnetic circuit system is configured to drive the vibration system to vibrate.

In the related technologies, the magnetic circuit system and the magnet assembly of the multifunctional sound generating device are designed into two separate magnetic circuit structures, which may reduce the overall mass of the vibration unit, make driving force of the vibration unit insufficient, and ultimately lead to weak vibration sense of the multifunctional sound generating device and degraded performance.

Therefore, it is necessary to provide a new multifunctional sound generating device to solve the above-mentioned technical problems.

### SUMMARY

Embodiments of the present disclosure aim to provide a multifunctional sound generating device to solve the problems in the related technologies that the vibration unit of the multifunctional sound generating device is light in weight and the driving force is insufficient, which leads to weak vibration sense and degradation of performance of the multifunctional sound generating device.

In view of the above, the present disclosure provides a multifunctional sound generating device including a housing, a vibration unit received in the housing, and a driving coil configured to drive the vibration unit to vibrate. The vibration unit includes a sound generating unit elastically supported on the housing and at least one magnet assembly fixed to the sound generating unit. The sound generating unit includes a basin frame, a vibration system and a magnetic circuit system fixed to the basin frame, where the magnetic circuit system is configured to drive the vibration system to vibrate and output sound. The vibration system includes a diaphragm fixed to the basin frame and a voice coil configured to drive the diaphragm to vibrate and output the sound. The magnetic circuit system includes a lower engaging plate, an annular main magnet fixed to the lower engaging plate, and at least one secondary magnet fixed to the lower engaging plate and located on an outer side of the main magnet. The at least one secondary magnet and the main magnet are spaced apart from each other to form a magnetic gap, and the voice coil is inserted into and suspended in the magnetic gap. The at least one magnet assembly is fixed to an inner side of the main magnet, the driving coil is fixed in the housing and located on the inner side of the main magnet, and the driving coil is spaced apart from the at least one magnet assembly and configured to drive the vibration unit to vibrate in a direction perpendicular to a vibration direction of the diaphragm.

In some embodiments, the at least one magnet assembly include two groups of magnet assemblies respectively fixed to an inner peripheral side of the main magnet, the two groups of magnet assemblies are provided on two opposite sides of the main magnet in a vibration direction of the vibration unit, and the driving coil is disposed between the two groups of the magnet assemblies. Each group of magnet assemblies of the two groups of magnet assemblies includes three driving magnets spaced apart from each other and arranged side by side in the vibration direction of the vibration unit, and the three driving magnets in one group of magnet assemblies of the two groups of magnet assemblies and the three driving magnets in another group of magnet assemblies of the two groups of magnet assemblies are arranged in one-to-one correspondence.

In some embodiments, a magnetization direction of the main magnet is parallel to a vibration direction of the vibration system, and a magnetization direction of each of the driving magnets of the two groups of magnet assemblies is perpendicular to the magnetization direction of the main magnet. A magnetization direction of a driving magnet located in the middle of the one group of magnet assemblies is opposite to a magnetization direction of a driving magnet located in the middle of the other group of magnet assemblies. The magnetization direction of the driving magnet located in the middle of the one group of magnet assemblies is the same as a magnetization direction of each of driving magnets located on both sides of the other group of magnet assemblies.

In some embodiments, the multifunctional sound generating device further includes a frame fixed to the housing and located on the inner side of the main magnet. The frame spaced apart from the at least one magnet assembly, and the driving coil is wound on the frame.

In some embodiments, the frame defines an annular groove recessed inwardly on a surface of the frame, and the driving coil is wound inside the groove.

In some embodiments, the multifunctional sound generating device further includes a flexible printed circuit fixed in the housing and electrically connected with the driving coil. The flexible printed circuit extends to outside the housing at an end away from the driving coil.

In some embodiments, the multifunctional sound generating device further includes two elastic pieces, and the two elastic pieces elastically support two opposite sides of the lower engaging plate to the housing.

In some embodiments, the main magnet includes four sub-magnets fixed to the lower engaging plate, and the four sub-magnets are spliced sequentially and jointly form a ring shape. The at least one secondary magnet includes four secondary magnets, and each of the four secondary magnets is disposed on outside of a corresponding sub-magnet of the four sub-magnets.

In some embodiments, the magnetic circuit system further includes an upper engaging plate fixed to a side of the four sub-magnets away from the lower engaging plate and four secondary pole cores integrally formed with the basin frame and stacked on a side of the four secondary magnets away from the lower engaging plate respectively.

In some embodiments, the four secondary magnets are divided into a first group of magnets including two secondary magnets facing each other and a second group of magnets including two secondary magnets facing each other. Each of the two secondary magnets in the first group of magnets includes a magnet body and a protrusion portion formed by protruding and extending from a middle region of the magnet body in a direction away from the main magnet. The vibration system further includes two elastic members respectively disposed in one-to-one correspondence with two secondary magnets in the first group of magnets. Each of the two elastic members is spaced apart from a corresponding secondary magnet of the two secondary magnets in the first group of magnets, and includes a first fixed arm, two second fixed arms spaced apart from each other and fixed to the voice coil, and two elastic arms formed by bending and extending from the first fixed arm toward the two second fixed arms respectively and forming a fixed connection. The first fixed arm defines an avoidance groove (e.g., a U-shaped groove) for avoiding the protrusion portion at a middle region of the first fixed arm, and the two elastic arms are bent and extended in a direction toward the protrusion portion respectively. One elastic member of the two elastic members forms an electrical connection with the voice coil, the one elastic member forming an electrical connection with the voice coil further includes an extension portion formed by extending the first fixed arm in a direction toward the housing, and the extension portion extends outside the housing.

Compared with the related technologies, in the multifunctional sound generating device of the present disclosure, the main magnet is designed to have an annular shape, the at least one magnet assembly is fixed to the inner side of the main magnet, the driving coil is fixed in the housing, the driving coil is provided at the inner side of the main magnet, and the driving coil and the at least one magnet assembly are spaced apart from each other to cause the driving coil to drive the vibration unit to vibrate in the direction perpendicular to the vibration direction of the diaphragm. With such configuration, the magnetic circuit system can be integrated with the magnet assembly to improve the overall mass and driving force of the vibration unit, thereby enhancing the BL value and vibration sensation of the multifunctional sound emitting device, improving the performance of the multifunctional sound emitting device. In addition, such configuration can also make the short signal of the multifunctional sound emitting device clearer and save costs.

### BRIEF DESCRIPTION OF THE DRAWINGS

In order to more clearly explain the technical solutions in the embodiments of the present disclosure, the accompanying drawings that need to be used in the description of the embodiments will be briefly introduced below, and it is obvious that the accompanying drawings in the following description are only some embodiments of the present disclosure, and other accompanying drawings can be obtained from these accompanying drawings without making creative labor for those skilled in the art.

FIG. 1 is a three-dimensional schematic structural diagram of a multifunctional sound generating device according to an embodiment of the present disclosure.

FIG. 2 is a structural exploded view of a multifunctional sound generating device according to an embodiment of the present disclosure.

FIG. 3 is a cross-sectional view taken along line A-A of FIG. 1.

FIG. 4 is a sectional view taken along line B-B of FIG. 1.

FIG. 5 is a schematic diagram of magnetization of a magnetic circuit system and a magnet assembly in a multifunctional sound generating device according to an embodiment of the present disclosure.

FIG. 6 is a partial schematic structural diagram of a multifunctional sound generating device according to an embodiment of the present disclosure.

Reference numerals in the figures are illustrated as follows: 100, multifunctional sound generating device; 1, housing; 11, first housing; 12, second housing; 2, vibration unit; 21, sound generating unit; 211, basin frame; 2111, connecting member; 212, vibration system; 2121, diaphragm; 2122, voice coil; 2123, elastic member; 21231; first fixed arm; 21232; second fixed arm; 21233, elastic arm; 21234; avoidance groove; 21235, extension portion; 213, magnetic circuit system; 2131, lower engaging plate; 2132, main magnet; 21321, sub-magnet; 2133, secondary magnet; 21331, magnet body; 21332, protrusion portion; 2134, upper engaging plate; 2135, secondary pole core; 22, magnet assembly; 221, driving magnet; 3, driving coil; 4, frame; 41, groove; 5, flexible printed circuit; 6, elastic piece; 10; sound outlet hole; 20, magnetic gap.

### DETAILED DESCRIPTION OF THE EMBODIMENTS

Hereinafter, the technical solutions in the embodiments of the present disclosure will be clearly and completely described with reference to the drawings in the embodiments of the present disclosure, and it is obvious that the described embodiments are only a part of the embodiments of the present disclosure, rather than all the embodiments. Based on the embodiments in the present disclosure, all other embodiments obtained by those skilled in the art without making creative efforts fall within the scope of protection of the present disclosure.

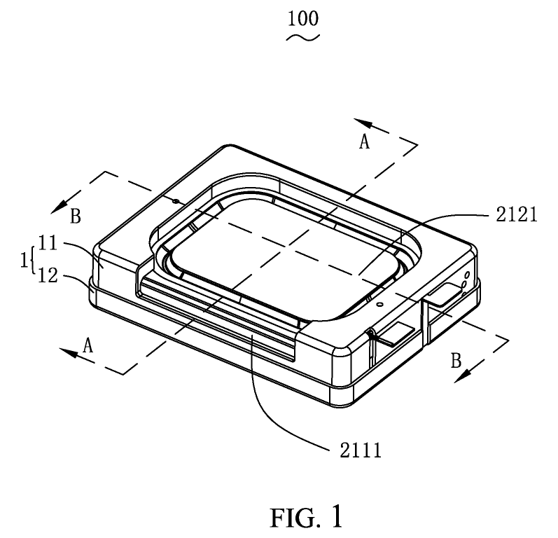

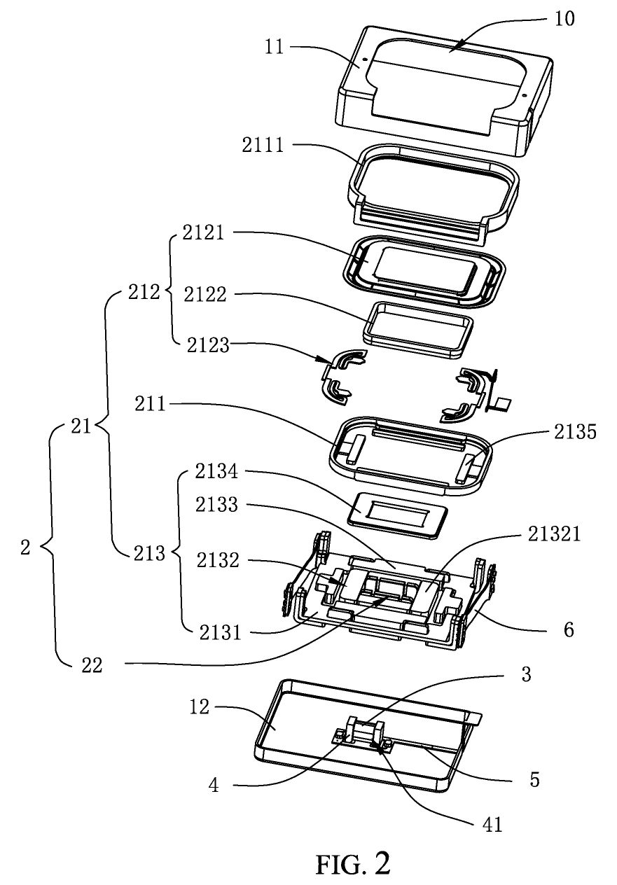

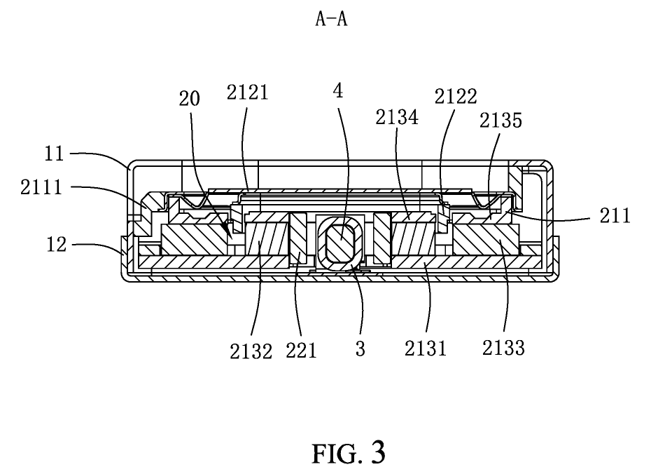

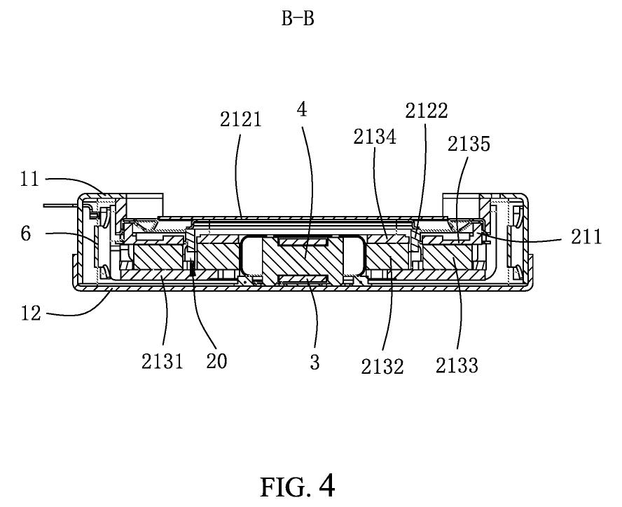

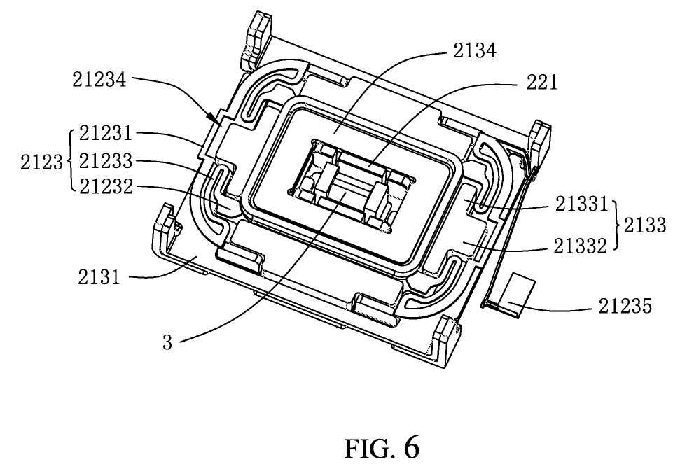

Embodiments of the present disclosure provide a multifunctional sound generating device 100, which includes a housing 1, a vibration unit 2 received in the housing 1, and a driving coil 3 configured to drive the vibration unit 2 to vibrate, as shown in FIGS. 1 to 6.

The housing 1 has a rectangular shape. The housing 1 includes a first housing 11 and a second housing 12 covering the first housing 11. The first housing 11 defines a sound outlet hole 10 running through the first housing 11. The second housing 12 and the first housing 11 jointly define a receiving space. The vibration unit 2 is accommodated in the receiving space.

The vibration unit 2 includes a sound generating unit 21 elastically supported on the housing 1, and at least one magnet assembly 22 fixed to the sound generating unit 21.

The sound generating unit 21 includes a basin frame 211, a vibration system 212 fixed to a side of two opposite sides of the basin frame 211, and a magnetic circuit system 213 fixed to another side of the two opposite sides of the basin frame 211. The magnetic circuit system 213 is configured to drive the vibration system 212 to vibrate and output sound. The basin frame 211 is elastically supported at a peripheral edge of the sound outlet hole 10 by a connecting member 2111 having elastic deformation performance to achieve sealing the sound outlet hole 10.

The vibration system 212 includes a diaphragm 2121 fixed to the basin frame 211, and a voice coil 2122 fixed to a side of the diaphragm 2121 close to the magnetic circuit system 213 and configured to drive the diaphragm 2121 to vibrate and output sound. The diaphragm 2121 is aligned with the sound outlet hole 10.

The magnetic circuit system 213 includes a lower engaging plate 2131, an annular main magnet 2132 fixed to the lower engaging plate 2131, and at least one secondary magnet 2133 fixed to the lower engaging plate 2131 and located on an outer side of the main magnet 2132. The lower engaging plate 2131 is elastically supported on the housing 1. Specifically, the lower engaging plate 2131 is elastically supported on the first housing 11. The at least one secondary magnet 2133 and the main magnet 2132 are spaced apart from each other to define a magnetic gap 20, and the voice coil 2122 is inserted into and suspended in the magnetic gap 20. It shall be understood that, although the sound generating unit 21 is elastically supported on the first housing 11 of the housing 1 through the lower engaging plate 2131, there is no restriction on the manner in which the sound generating unit 21 is elastically supported on the first housing 11 in the disclosure.

The annular main magnet 2132 includes following three kinds of designs: the first kind of design is that the main magnet 2132 is designed as a whole ring-shaped structure, the second kind of design is that the main magnet 2132 is designed as a ring structure formed by splicing a plurality of sub-magnets 21321 sequentially, and the third kind of design is that the main magnet 2132 is designed as a broken annular structure with notches, and the notches can be designed as one or a plurality of notches arranged at intervals.

In this embodiment, the main magnet 2132 includes four sub-magnets 21321, which are fixed to the lower engaging plate 2131. The four sub-magnets 21321 are spliced sequentially and jointly form a ring shape. The at least one secondary magnet 2133 includes four secondary magnets 2133, where each of the four secondary magnets 2133 is disposed on outside of a corresponding sub-magnet 21321 of the four sub-magnets 21321.

The four secondary magnets 2133 are divided into a first group of magnets including two secondary magnets 2133 facing each other and a second group of magnets including two secondary magnets 2133 facing each other. Each of the two secondary magnets 2133 in the first group of magnets includes a magnet body 21331 and a protrusion portion 21332 formed by protruding and extending from a middle region of the magnet body 21331 in a direction away from the main magnet 2132. It shall be understood that, the two secondary magnets 2133 in the second group of magnets may also be designed in a same structure as the two secondary magnets 2133 in the first group of magnets. For example, each of the two secondary magnets 2133 in the second group of magnets also includes a magnet body 21331 and a protrusion portion 21332 formed by protruding and extending from a middle region of the magnet body 21331 in a direction away from the main magnet.

The magnetic circuit system 213 further includes an upper engaging plate 2134 fixed to a side of the four sub-magnets 21321 away from the lower engaging plate 2131, and four secondary pole cores 2135 integrally formed with the basin frame 211 and stacked on a side of the four secondary magnets 2133 away from the lower engaging plate 2131, respectively. It shall be understood that if there is no secondary pole cores 2135, the side of the four secondary magnets 2133 away from the lower engaging plate 2131 can be directly fixedly connected to the basin frame 211.

After the voice coil 2122 is energized/powered on, the voice coil 2122 generates a force with the magnetic circuit system 213, to drive the sound generating unit 21 to move in a vibration direction of the diaphragm 2121.

The at least one magnet assembly 22 is fixed to an inner side of the main magnet 2132, where the inner side of the main magnet 2132 refers to a side of the main magnet 2132 away from the secondary magnets 2133. The at least one magnet assembly 22 may be fixed directly to the main magnet 2132 or may be fixed to the main magnet 2132 by other connecting members. Such design may allow both the at least one magnet assembly 22 and the magnetic circuit system 213 to be the mass of the vibration unit 2 to save costs and improve overall performance.

The at least one magnet assembly 22 include two groups of magnet assemblies 22 respectively fixed on an inner peripheral side of the main magnet 2132. The two groups of magnet assemblies 22 are provided on two opposite sides of the main magnet 2132 in a vibration direction of the vibration unit 2. That is, the two groups of magnet assemblies 22 are provided on two opposite sub-magnets of the main magnet 2132 that are extended in a direction perpendicular to an extending direction of the elastic pieces 6 described below. The driving coil 3 is disposed between the two groups of magnet assemblies 22. Each group of magnet assemblies 22 of the two groups of magnet assemblies 22 includes three driving magnets 221 spaced apart from each other and arranged side by side in the vibration direction of the vibration unit 2. The three driving magnets 221 in one group of magnet assemblies 22 and the three driving magnets 221 in the other group of magnet assemblies 22 are arranged in one-to-one correspondence. After the driving coil 3 is energized, the driving coil 3 may generate a force with the six driving magnets 221 to drive the multifunctional sound generating device 100 to move in a direction perpendicular to the vibration direction of the diaphragm 2121.

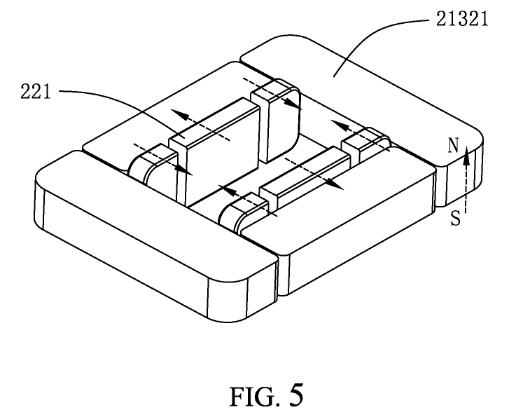

A magnetization direction of the main magnet 2132 is parallel to a vibration direction of the vibration system 212, that is, the magnetization direction of the main magnet 2132 is parallel to the vibration direction of the diaphragm 2121. A magnetization direction of each of all the six driving magnets 221 is perpendicular to the magnetization direction of the main magnet 2132. A magnetization direction of a driving magnet 221 located in the middle of one group of magnet assemblies 22 is opposite to a magnetization direction of a driving magnet 221 located in the middle of the other group of magnet assemblies 22. The magnetization direction of the driving magnet 221 located in the middle of any group of magnet assemblies 22 is the same as a magnetization direction of each of driving magnets 221 located on both sides of another group of magnet assemblies 22. Specifically, the magnetization direction of the driving magnet 221 located in the middle of each group of magnet assemblies 22 of the two groups of magnet assemblies 22 is facing away from the driving coil 3. The magnetization direction of each driving magnet is shown by a dotted line in FIG. 5.

The driving coil 3 is fixed in the housing 1 and located on the inner side of the main magnet 2132, and the driving coil 3 is spaced apart from the two groups of magnet assemblies 22.

The multifunctional sound generating device 100 further includes a frame 4 fixed to the housing 1 and located on the inner side of the main magnet 2132. The frame 4 is spaced apart from the two groups of magnet assemblies 22. The driving coil 3 is wound on the frame 4. Specifically, the frame 4 is fixed to the second housing 12. The frame 4 defines an annular groove 41 recessed inwardly on a surface of the frame 4, and the driving coil 3 is wound inside the groove 41.

The multifunctional sound generating device 100 further includes a flexible printed circuit 5 fixed in the housing 1 and electrically connected with the driving coil 3. An end of the flexible printed circuit 5 away from the driving coil 3 extends to outside of the housing 1. Such design can facilitate electrical connection between the driving coil 3 and an external power supply.

The multifunctional sound generating device 100 further includes two elastic pieces 6, and the two elastic pieces 6 elastically support opposite sides of the lower engaging plate 2131 to the housing 1. Specifically, the two elastic pieces 6 elastically support opposite sides of the lower engaging plate 2131 to the first housing 11.

In addition, the vibration system 212 further includes two elastic members 2123 respectively disposed in one-to-one correspondence with the two secondary magnets 2133 in the first group of magnets, where each of the two secondary magnets 2133 in the first group of magnets 2133 corresponds to one sub-magnet 21321 of two sub-magnets 21321 without being provided with driving magnets 221. Each of the two elastic members 2123 is spaced apart from a corresponding secondary magnet 2133 of the two secondary magnets 2133 in the first group of magnets. Each of the two elastic members 2123 include a first fixed arm 21231, two second fixed arms 21232 spaced apart from each other and fixed to the voice coil 2122, and two elastic arms 21233 formed by bending and extending from the first fixed arm 21231 toward the two second fixed arms 21232 respectively and forming a fixed connection, that is, each of the two elastic arms 21233 is fixedly connected between the first fixed arm 21231 and a corresponding second fixed arm of the two second fixed arms 21232. The first fixed arm 21231 defines an avoidance groove 21234 for avoiding the protrusion portion 21332 at a middle region of the first fixed arm 21231, and the two elastic arms 21233 are bent and extended in a direction toward the protrusion portion 21332 respectively. One elastic member of the two elastic members 2123 is a flexible printed circuit and forms an electrical connection with the voice coil 2122. The one elastic member 2123 forming an electrical connection with the voice coil 2122 further includes an extension portion 21235 formed by extending the first fixed arm 21231 in a direction toward the housing 1. The extension portion 21235 extends outside the housing 1. Specifically, the first fixed arm 21231 has an arc-shaped structure. Such design can not only save the arrangement space required for the elastic member 2123, but also realize the electrical connection between the voice coil 2122 and the external power supply.

Compared with the related technologies, in the multifunctional sound generating device 100 of the present disclosure, the main magnet 2132 is designed to have an annular shape, the at least one magnet assembly 22 is fixed to the inner side of the main magnet 2132, the driving coil 3 is fixed in the housing 1, the driving coil 3 is provided on the inner side of the main magnet 2132, and the driving coil 3 and the at least one magnet assembly 22 are spaced apart from each other to cause the driving coil 3 to drive the vibration unit 2 to vibrate in the direction perpendicular to the vibration direction of the diaphragm 2121. With such configuration, the magnetic circuit system 213 can be integrated with the magnet assembly 22 to improve the overall mass and driving force of the vibration unit 2, thereby enhancing the BL value and vibration sensation of the multifunctional sound emitting device 100, improving the performance of the multifunctional sound emitting device 100. In addition, such configuration can also make the short signal of the multifunctional sound emitting device 100 clearer and save costs.

The above description is merely some embodiments of the present disclosure, and it is to be pointed out here that those skilled in the art can make improvements without departing from the inventive concept of the present disclosure, but these are all within the scope of protection of the present disclosure.

What is claimed is:

1. A multifunctional sound generating device, comprising a housing, a vibration unit received in the housing, and a driving coil configured to drive the vibration unit to vibrate;
wherein the vibration unit includes a sound generating unit elastically supported on the housing and at least one magnet assembly fixed to the sound generating unit;
wherein the sound generating unit includes a basin frame, and a vibration system and a magnetic circuit system that are fixed to the basin frame, wherein the magnetic circuit system is configured to drive the vibration system to vibrate and output sound, wherein the vibration system includes a diaphragm fixed to the basin frame and a voice coil configured to drive the diaphragm to vibrate and output the sound, wherein the magnetic circuit system includes a lower engaging plate, an annular main magnet fixed to the lower engaging plate, and at least one secondary magnet fixed to the lower engaging plate and located on an outer side of the main magnet, wherein the at least one secondary magnet and the main magnet are spaced apart from each other to form a magnetic gap, and the voice coil is inserted into and suspended in the magnetic gap; and
wherein the at least one magnet assembly is fixed to an inner side of the main magnet, the driving coil is fixed in the housing and located on the inner side of the main magnet, and the driving coil is spaced apart from the at least one magnet assembly and configured to drive the vibration unit to vibrate in a direction perpendicular to a vibration direction of the diaphragm.

2. The multifunctional sound generating device of claim 1, wherein the at least one magnet assembly include two groups of magnet assemblies respectively fixed to an inner peripheral side of the main magnet, the two groups of magnet assemblies are provided on two opposite sides of the main magnet in a vibration direction of the vibration unit, and the driving coil is disposed between the two groups of the magnet assemblies;
wherein each group of magnet assemblies of the two groups of magnet assemblies includes three driving magnets spaced apart from each other and arranged side by side in the vibration direction of the vibration unit, and the three driving magnets in one group of magnet assemblies of the two groups of magnet assemblies and the three driving magnets in another group of magnet assemblies of the two groups of magnet assemblies are arranged in one-to-one correspondence.

3. The multifunctional sound generating device of claim 2, wherein a magnetization direction of the main magnet is parallel to a vibration direction of the vibration system, and a magnetization direction of each of the driving magnets of the two groups of magnet assemblies is perpendicular to the magnetization direction of the main magnet;
wherein a magnetization direction of a driving magnet located in the middle of the one group of magnet assemblies is opposite to a magnetization direction of a driving magnet located in the middle of the other group of magnet assemblies, and wherein the magnetization direction of the driving magnet located in the middle of the one group of magnet assemblies is the same as a magnetization direction of each of driving magnets located on both sides of the other group of magnet assemblies.

4. The multifunctional sound generating device of claim 1, wherein the multifunctional sound generating device further comprises a frame fixed to the housing and located on the inner side of the main magnet, wherein the frame spaced apart from the at least one magnet assembly, and the driving coil is wound on the frame.

5. The multifunctional sound generating device of claim 4, wherein the frame defines an annular groove recessed inwardly on a surface of the frame, and the driving coil is wound inside the groove.

6. The multifunctional sound generating device of claim 1, wherein the multifunctional sound generating device further comprises a flexible printed circuit fixed in the housing and electrically connected with the driving coil, and wherein the flexible printed circuit extends outside the housing at an end away from the driving coil.

7. The multifunctional sound generating device of claim 1, wherein the multifunctional sound generating device further comprises two elastic pieces, and the two elastic pieces elastically support two opposite sides of the lower engaging plate to the housing.

8. The multifunctional sound generating device of claim 1, wherein the main magnet includes four sub-magnets fixed to the lower engaging plate, and the four sub-magnets are spliced sequentially and jointly form a ring shape;
wherein the at least one secondary magnet includes four secondary magnets, and each of the four secondary magnets is disposed on outside of a corresponding sub-magnet of the four sub-magnets.

9. The multifunctional sound generating device of claim 8, wherein the magnetic circuit system further comprises an upper engaging plate fixed to a side of the four sub-magnets away from the lower engaging plate and four secondary pole cores integrally formed with the basin frame and stacked on a side of the four secondary magnets away from the lower engaging plate respectively.

10. The multifunctional sound generating device of claim 8, wherein the four secondary magnets are divided into a first group of magnets including two secondary magnets facing each other and a second group of magnets including two secondary magnets facing each other, wherein each of the two secondary magnets in the first group of magnets includes a magnet body and a protrusion portion formed by protruding and extending from a middle region of the magnet body in a direction away from the main magnet;
wherein the vibration system further includes two elastic members respectively disposed in one-to-one correspondence with two secondary magnets in the first group of magnets, wherein each of the two elastic members is spaced apart from a corresponding secondary magnet of the two secondary magnets in the first group of magnets, and includes a first fixed arm, two second fixed arms spaced apart from each other and fixed to the voice coil, and two elastic arms formed by bending and extending from the first fixed arm toward the two second fixed arms respectively and forming a fixed connection; and
wherein the first fixed arm defines an avoidance groove for avoiding the protrusion portion at a middle region of the first fixed arm, and the two elastic arms are bent and extended in a direction toward the protrusion portion respectively, wherein one elastic member of the two elastic members forms an electrical connection with the voice coil, the one elastic member forming an electrical connection with the voice coil further comprises an extension portion formed by extending the first fixed arm in a direction toward the housing, and the extension portion extends outside the housing.
